(19) United States
(12) Patent Application Publication
(10) Pub. No.: US 2015/0055079 A1
(43) Pub. Date: Feb. 26, 2015

(54) EYEWEAR TECHNOLOGIES

(71) Applicant: KLAR Scientific LLC, Woodmere, NY (US)

(72) Inventors: Rafael Simcha Holzer, Woodmere, NY (US); Elan Kiderman, New Rochelle, NY (US); Spencer Samuel Penn, New York, NY (US); Edward Lando, Philadelphia, PA (US)

(21) Appl. No.: 14/466,884

(22) Filed: Aug. 22, 2014

Related U.S. Application Data
(60) Provisional application No. 61/868,839, filed on Aug. 22, 2013.

(51) Int. Cl. G02C 5/00; G02C 5/22

(52) U.S. Cl. CPC G02C 5/001; G02C 5/2209; G02C 5/2263; G02C 5/2218
USPC 351/86; 351/115; 351/83; 351/114

(57) ABSTRACT

A device comprising an eyewear frame, a link coupled to the eyewear frame for pivoting about a first vertical axis, and an arm coupled to the link for pivoting about a second vertical axis.

### CROSS-REFERENCE TO RELATED APPLICATIONS

The present application claims priority to U.S. Provisional Patent Application Ser. No. 61/868,839, filed on Aug. 22, 2013, which is herein fully incorporated by reference for all purposes.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

A person often desires to wear different eyewear frames for different occasions. For example, the person may wear a first eyewear frame with a first visual appearance to a first event, such as a conference, and a second eyewear frame with a second visual appearance, different from the first appearance, to a second event, such as a party. However, such desire may be difficult to attain. For example, the person may be unable to carry more than one eyewear frame at a time or the person may have forgotten the other pair at home.

### BRIEF SUMMARY

The present disclosure may at least partially address at least one of the above. However, the present disclosure may prove useful to other technical areas. Therefore, the claims should not be construed as necessarily limited to addressing any of the above.

An example embodiment of the present disclosure provides a device comprising an eyewear frame, a link coupled to the eyewear frame for pivoting about a first vertical axis, and an arm coupled to the link for pivoting about a second vertical axis.

In another embodiment, the device may further comprise a pin extending through the eyewear frame and the link. The pin facilitates pivoting of the link about the first axis.

In another embodiment, the device may further comprise a pin extending through the arm and the link. The pin facilitates pivoting of the arm about the second axis.

In another embodiment, the device may further comprise a first protrusion extending vertically from the eyewear frame. The first protrusion extends through the link to facilitate pivoting of the link about the first axis. The device may further comprise a second protrusion extending vertically from the eyewear frame toward the first protrusion. The second protrusion extends through the link to facilitate pivoting of the link about the first axis.

In another embodiment, the device may further comprise a pair of lenses. The eyewear frame comprises a pair of lens retaining portions, a first face, and a second face. The lens retaining portions retaining the lenses such that the lenses are interchangeable between the lens retaining portions when flipped for switching the eyewear frame for use from the first face to the second face.

In another embodiment, the device may further comprise a lens receiver coupled to one of the lens. The receiver is configured for coupling to the eyewear frame.

In another embodiment, the device may further comprise the lens receiver framing the one of the lens.

In another embodiment, the device may further comprise a plurality of lens frame members coupled to one of the lens. The lens frame members fully enclose the one of the lens. At least one of the lens frame members is configured for coupling to the eyewear frame.

In another embodiment, the device may further comprise the eyewear frame comprising a pivoting member for horizontal axis pivoting thereabout. The eyewear frame comprising a first face and a second face. The link is coupled to the eyewear frame via the pivoting member such that the arm is horizontally pivoted thereby for switching the eyewear frame for use from the first face to the second face.

In another embodiment, the device may further comprise the arm comprising a bend portion rotating about the arm such that the bend portion facilitates switching of the eyewear frame for use from the first face to the second face based on the arm horizontally pivoting via the pivoting member.

In another embodiment, the device may further comprise the arm comprising a bend portion. The arm is rotatable with respect to the link such that the bend portion facilitates switching of the eyewear frame for use from the first face to the second face based on the arm horizontally pivoting via the pivoting member.

In another embodiment, the device may further comprise the arm comprising a bend portion. The link is rotatable with respect to the frame such that the bend portion facilitates switching of the eyewear frame for use from the first face to the second face based on the arm horizontally pivoting via the pivoting member.

In another embodiment, the device may further comprise the eyewear frame comprising a first face and a second face. The arm comprising a bend portion configured for flipping between a first position and a second position. The first position corresponding to use of the eyewear frame based on the first face and the second position corresponding to use of the eyewear frame based on the second face.

In another embodiment, the device may further comprise the link comprising a protrusion and the arm comprising a plurality of depressions configured for engaging the protrusion such that the arm is repositioned thereby.

In another embodiment, the device may further comprise the arm comprising a protrusion and the link comprising a plurality of depressions configured for engaging the protrusion such that the arm is repositioned thereby.

In another embodiment, the device may further comprise the link comprising a protrusion and the eyewear frame comprising a plurality of depressions configured for engaging the protrusion such that the link is repositioned thereby.

In another embodiment, the device may further comprise the eyewear frame comprising a protrusion and the link comprising a plurality of depressions configured for engaging the protrusion such that the link is repositioned thereby.

In another embodiment, the device may further comprise the link being coupled to the eyewear frame in a ball-and-socket configuration.

In another embodiment, the device may further comprise the eyewear frame and the link coupled magnetically.

In another embodiment, the device may further comprise the link and the arm coupled magnetically.

In another embodiment, the device may further comprise a first protrusion extending vertically from the arm. The first protrusion extends through the link to facilitate pivoting of the link about the second axis. The device may further comprise a second protrusion extending vertically from the arm toward the first protrusion. The second protrusion extends through the link to facilitate pivoting of the link about the second axis.

In another embodiment, the device may further comprise a first protrusion extending vertically from the link. The first protrusion extends through the eyewear frame to facilitate pivoting of the link about the first axis. The device may further comprise a second protrusion extending vertically from the link away from the first protrusion. The second protrusion extends through the eyewear frame to facilitate pivoting of the link about the first axis.

In another embodiment, the device may further comprise a first protrusion extending vertically from the link. The first protrusion extends through the arm to facilitate pivoting of the link about the second axis. The device may further comprise a second protrusion extending vertically from the link away from the first protrusion. The second protrusion extending through the arm to facilitate pivoting of the link about the second axis.

Another example embodiment of the present disclosure provides a device comprising an eyewear lens and a lens frame fully enclosing the lens. The lens frame is configured for coupling to an eyewear frame removably.

Yet another example embodiment of the present disclosure provides a device comprising an eyewear frame comprising a first face, a second face, and an elastic member. The device further comprises an arm coupled to the eyewear frame for vertical axis pivoting thereabout to enable selective use of the eyewear frame based on the first face and the second face. The elastic member is in tension as the arm is vertical axis pivoted between a first position and a second position. The first position corresponds to use of the eyewear frame based on the first face and the second position corresponding to use of the eyewear frame based on the second face.

In another embodiment, the device may further comprise a pair of lenses. The eyewear frame comprising a pair of lens retaining portions. The portions retaining the lenses such that the lenses are interchangeable between the portions when flipped for switching the eyewear frame for use from the first face to the second face.

In another embodiment, the device may further comprise a lens receiver coupled to one of the lens. The receiver is configured for coupling to the eyewear frame.

In another embodiment, the device may further comprise the lens receiver framing the one of the lens.

In another embodiment, the device may further comprise a plurality of lens frame members coupled to one of the lens. The lens frame members fully enclose the one of the lens. At least one of the lens frame members is configured for coupling to the eyewear frame.

In another embodiment, the device may further comprise the eyewear frame comprising a pivoting member for horizontal axis pivoting thereabout. The pivoting member comprising the elastic member. The pivoting member pivoting the arm horizontally for switching the eyewear frame for use from the first face to the second face.

In another embodiment, the device may further comprise the arm comprising a bend portion rotating about the arm such that the bend portion facilitates switching of the eyewear frame for use from the first face to the second face based on the arm horizontally pivoting via the pivoting member.

In another embodiment, the device may further comprise the arm comprising a bend portion. The arm is rotatable with respect to the pivoting member such that the bend portion facilitates switching of the eyewear frame for use from the first face to the second face based on the arm horizontally pivoting via the pivoting member.

In another embodiment, the device may further comprise the arm comprising a bend portion configured for flipping between a first posture and a second posture. The first posture corresponding to use of the eyewear frame based on the first face and the second posture corresponding to use of the eyewear frame based on the second face.

In another embodiment, the device may further comprise the eyewear frame comprising a protrusion and the arm comprising a plurality of depressions configured for engaging the protrusion such that the arm is repositioned thereby.

In another embodiment, the device may further comprise the arm comprising a protrusion and the eyewear frame comprising a plurality of depressions configured for engaging the protrusion such that the arm is repositioned thereby.

In another embodiment, the device may further comprise the eyewear frame and the arm coupled magnetically.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows an exploded view of an example embodiment of an eyewear device according to the present disclosure.

FIG. 2A shows a profile view of an example embodiment of an eyewear frame comprising a pair of protrusions according to the present disclosure.

FIG. 2B shows a profile view of an example embodiment of a link comprising a pair of protrusions according to the present disclosure.

FIG. 3A shows a profile view of an example embodiment of a rotation member according to the present disclosure.

FIG. 3B shows a profile view of another example embodiment of a rotation member according to the present disclosure.

FIG. 4A shows a front view of an example embodiment of a lens receiver in receipt of a lens according to the present disclosure.

FIG. 4B shows a front view of an example embodiment of a pair of lens receivers in receipt of a lens according to the present disclosure.

FIG. 4C shows a front view of an example embodiment of a frame containing a lens according to the present disclosure.

FIG. 4D shows a profile view of an example embodiment of a lens receiver according to the present disclosure.

FIG. 4E shows a front view of an example embodiment of a lens in a squashed rectangle shape according to the present disclosure.

FIG. 4F shows a front view of an example embodiment of a lens in a triangular shape according to the present disclosure.

FIG. 4G shows a front view of an example embodiment of a lens in a beveled rectangle shape according to the present disclosure.

FIG. 4H shows a front view of an example embodiment of a lens in a hexagon shape according to the present disclosure.

FIG. 4I shows a front view of an example embodiment of a lens in a D-shape according to the present disclosure.

FIG. 4J shows a front view of an example embodiment of a lens in a rhombus shape according to the present disclosure.

FIG. 4K shows a profile view of an example embodiment of a biconvex lens according to the present disclosure.

FIG. 4L shows a profile view of an example embodiment of a biconcave lens according to the present disclosure.

FIG. 4M shows a profile view of an example embodiment of a plano-convex lens according to the present disclosure.

FIG. 4N shows a profile view of an example embodiment of a plano-concave lens according to the present disclosure.

FIG. 5A shows a perspective view of an example embodiment of an eyewear device comprising a first face according to the present disclosure.

FIG. 5B shows a perspective view of an example embodiment of an eyewear device comprising a second face according to the present disclosure.

FIG. 6 shows a top view of an example embodiment of an eyewear device comprising a horizontal axis pivoting member according to the present disclosure.

FIG. 7A shows a front view of an example embodiment of an eyewear frame hosting a lens receiver in receipt of a lens according to the present disclosure.

FIG. 7B shows a front view of an example embodiment of an eyewear frame hosting a pair of lens receivers in receipt of a lens according to the present disclosure.

FIG. 7C shows a front view of an example embodiment of an eyewear frame hosting a frame containing a lens according to the present disclosure.

FIG. 8A shows a side view of an example embodiment of an arm comprising a pivoting bend portion according to the present disclosure.

FIG. 8B shows a side view of an example embodiment of an arm comprising a link potion and a bend portion rotating with respect to the link portion according to the present disclosure.

FIG. 8C shows a side view of an example embodiment of an arm rotating horizontally with respect to a link according to the present disclosure.

FIG. 8D shows a side view of an example embodiment of a link rotating horizontally with respect to an eyewear frame according to the present disclosure.

FIG. 9A shows a top view of an example embodiment of a bend portion in a first position according to the present disclosure.

FIG. 9B shows a top view of an example embodiment of a bend portion in flipped sideways to a second position according to the present disclosure.

FIG. 9C shows a top view of an example embodiment of a bend portion in a first position according to the present disclosure.

FIG. 9D shows a top view of an example embodiment of a bend portion in pivoted sideways to a second position according to the present disclosure.

FIG. 10A shows a top view of an example embodiment of a protrusion-depression mechanism according to the present disclosure.

FIG. 10B shows a front view of an example embodiment of a depression surface according to the present disclosure.

FIG. 11 shows a side view of an example embodiment of a link coupled to an eyewear frame in a ball-and-socket configuration according to the present disclosure.

FIG. 12A shows a top view of an example embodiment of an arm coupled to an eyewear frame pivotally for use with a first face according to the present disclosure.

FIG. 12B shows a top view of an example embodiment of an arm pivoting under tension via an elastic member according to the present disclosure.

FIG. 12C shows a top view of an example embodiment of an arm coupled to an eyewear frame after pivoting for use with a second face according to the present disclosure.

### DETAILED DESCRIPTION OF THE PREFERRED EMBODIMENTS

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art. In addition, features described with respect to certain example embodiments may be combined in and/or with various other example embodiments. Different aspects and/or elements of example embodiments, as disclosed herein, may be combined in a similar manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments only and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

In some embodiments, the term “or” as used herein, including the claims, is used to mean “and/or” unless explicitly indicated to refer to alternatives only or the alternatives are mutually exclusive.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes can include three dimensional (3D) printing, laser cutting, computer numerical control routing, milling, pressing, stamping, vacuum forming, hydroforming, injection molding, lithography, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

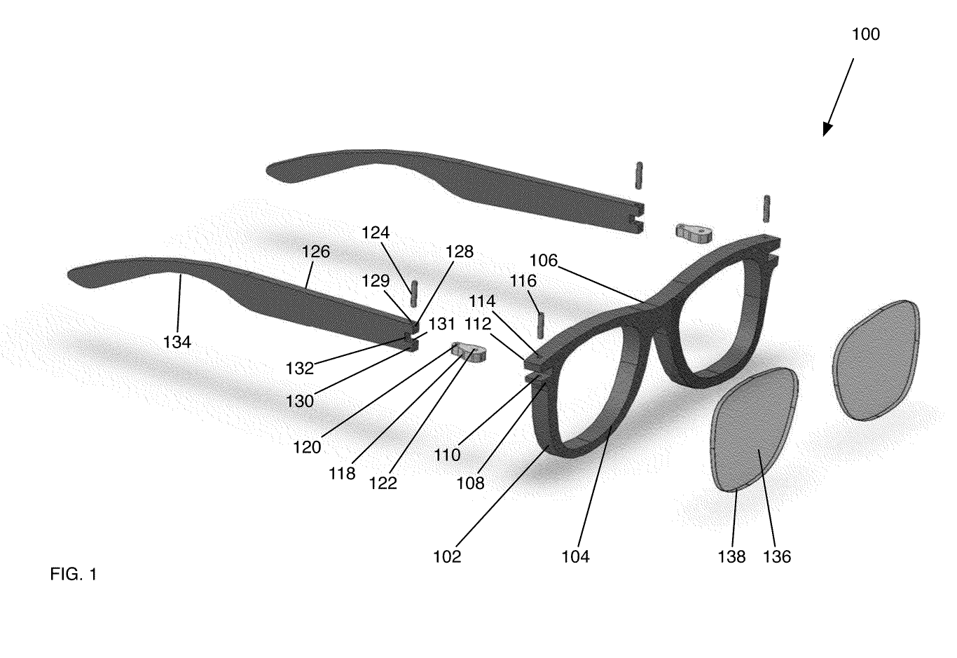

FIG. 1 shows an exploded view of an example embodiment of an eyewear device according to the present disclosure. An eyewear device 100 comprises an eyewear frame 102, a pair of links 118, and a pair of arms 126. The device 100 can be used for vision correction, eye protection, 3D viewing, gaming, magnification, or other suitable purposes. For example, the device 100 can comprise a sunglasses unit, a stereoscope eyeglasses unit, a bifocal eyeglasses unit, a safety goggles unit, a swimming goggles unit, a wearable optical head mounted display, or others.

The frame 102 is unitary, but in other embodiments is an assembly, such as via fastening, mating, interlocking, adhering, magnetizing, or other assembly manners. The frame 102 comprises plastic, but in other embodiments comprises at least one of a metal, a stone, and a natural material, or combinations thereof. The frame 102 comprises a pair of faces, one of which is exposed to a wearer of the frame 102 and the other of which is exposed to other people when the wearer of the frame 102 is around other people. The frame 102 comprises a pair of lens retaining portions 104 and a bridge 106 spanning therebetween. The lens retaining portions 104 are symmetrical, but in other embodiments are asymmetrical. The frame 102 further comprises a pair of cantilevered portions 108 and 112 at each side. The cantilevered portions 108 and 112 are symmetrical, but in other embodiments are asymmetrical. The cantilevered portion 108 defines a channel 110 therethrough. The cantilevered portion 112 defines a channel 114 therethrough. The channels 110 and 114 are symmetrical, but in other embodiments are asymmetrical. The channels 110 and 114 are shaped circularly, but in other embodiments are shaped differently, such as a triangle, an oval, a pentagon, or other suitable shapes. The cantilevered portion 108 and the cantilevered portion 112 are square in shape, but in other embodiments are shaped differently, such as a circle, a triangle, an oval, a pentagon, or other suitable shapes. The cantilevered portion 108 and the cantilevered portion 112 are spaced apart from each other such that the frame 102, the cantilevered portion 108 and the cantilevered portion 112 are in a U-shape arrangement. In some embodiments, at least one of the cantilevered portions 108 and 112 is lacking. In some embodiments, the frame 102 comprises a top bar extending above the bridge 106. In some embodiments, the frame 102 comprises a pair of nose pads extending from the lens retaining portions 104. Note that the frame 102 can comprise a pair of pad arms spanning between the nose pads and the lens retaining portions 104. In some embodiments, the frame 102 comprises a pair of end pieces from which the cantilevered portions 108 and 112 extend from.

The links 118 are symmetrical, but in other embodiments are asymmetrical. Each of the links 118 defines a channel 120 therethrough and a channel 122 therethrough. The channels 120 and 122 are symmetrical, but in other embodiments are asymmetrical. The channels 120 and 122 are shaped circularly, but in other embodiments are shaped differently, such as a triangle, an oval, a pentagon, or other suitable shapes. At least one of the links 118 comprises metal, but in other embodiments comprises at least one of a plastic, a stone, and a natural material, or combinations thereof. At least one of the links 118 is solid internally, but in other embodiments is hollow. At least one of the links 118 can be a lattice plate.

Each of the arms 126, also known as temples, comprises a cantilevered portions 128 and 130 with a base portion 132 extending therebetween. The cantilevered portion 128 defines a channel 129 therethrough. The cantilevered portion 130 defines a channel 131 therethrough. The channels 129 and 131 are symmetrical, but in other embodiments are asymmetrical. The channels 129 and 131 are shaped circularly, but in other embodiments are shaped differently, such as a triangle, an oval, a pentagon, or other suitable shapes. The cantilevered portion 128 and the cantilevered portion 130 are square in shape, but in other embodiments are shaped differently, such as a circle, a triangle, an oval, a pentagon, or other suitable shapes. The cantilevered portion 128 and the cantilevered portion 130 are spaced apart from each other such that the base portion 132, the cantilevered portion 108 and the cantilevered portion 112 are in a U-shape arrangement. In some embodiments, at least one of the cantilevered portions 128 and 130 is lacking.

Each of the arms 126 further comprises a bend portion 134. However, note that at least one of the arms 126 can be of any type, such as via lacking the bend portion 134. For example, at least one of the arms 126 can be structured based on at least one of a skull-temple type, a library-temple type, a convertible-temple type, a riding-bow temple type, and a comfort-cable temple type.

The device 100 further comprises a pin 116, which is sized for insertion into the channels 110 and 114 of the frame 102 and the channel 122 of the link 118. The pin 116 is or a part of a dowel, a screw, a rod, a bolt, a shaft, a hinge, or a needle. The pin 116 has a circular cross-section, but in other embodiments, the pin 116 has a cross-section of a different shape, such as a hexagon. The pin 116 comprises metal, but in other embodiments comprises at least one of a stone, and a natural material, or combinations thereof. The pin 116 can be smooth, threaded, fluted, or slotted. The pin 116 can comprise a head slotted for fastening with a screwdriver.

The device 100 further comprises a pin 124, which is sized for insertion into the channels 129 and 131 of the arm 126 and the channel 120 of the link. The pin 124 is or a part of a dowel, a screw, a rod, a bolt, a shaft, a hinge, or a needle. The pin 124 has a circular cross-section, but in other embodiments, the pin 116 has a cross-section of a different shape, such as a hexagon. The pin 124 comprises metal, but in other embodiments comprises at least one of a stone, and a natural material, or combinations thereof. The pin 124 can be smooth, threaded, fluted, or slotted. The pin 124 can comprise a head slotted for fastening with a screwdriver. The pin 124 and the pin 116 are symmetrical, but in other embodiments are asymmetrical. The pin 124 and the pin 116 have identically shaped cross-sections, but in other embodiments such cross-sections are differently shaped, such as the pin 116 being circular and the pin 124 being hexagonal.

Each of the links 118 is inserted into the U-shape configuration of the frame 102 such that the pin 116 is inserted into the channel 114, the channel 122, and the channel 110. Resultantly, each of the links 118 is coupled to the frame 102 for pivoting about a first vertical axis, such as via the pin 116. Such pivoting enables a wide range of motion for the links 118 with respect to the frame 102. For example, if the base of the U-shape configuration of the frame 102 is lacking, then the link 118 can pivot about 360 degrees. Otherwise, the link can pivot less than about 360 degrees, such as about 350 degrees. Note that each of the links 118 is coupled to the frame 102 in such a way such as to avoid free rotation of the link 118, such as via biasing or tension, for instance via a biasing mechanism or a biasing member or a tension mechanism or a tension member. However, in some embodiments, the link 118 freely rotates with respect to the frame 102.

Each of the links 118 is inserted into the U-shape configuration of the arm 126 such that the pin 124 is inserted into the channel 129, the channel 120, and the channel 131. Resultantly, each of the links 118 is coupled to the arm 126 for pivoting about a second vertical axis, such as via the pin 124. Such pivoting enables a wide range of motion for the links 118 with respect to the arms 126. For example, if the base 132 is sufficiently recessed/indented, then the link 118 can pivot about 360 degrees. Otherwise, the link can pivot less than about 360 degrees, such as about 350 degrees. Note that the arms 126 are coupled to the links 118 in such a way such as to avoid free rotations of the arms 126, such as via biasing or tension, for instance via a biasing mechanism or a biasing member or a tension mechanism or a tension member. However, in some embodiments, the arms 126 freely rotate with respect to the links 118.

The device 100 further comprises a pair of lenses, which each member of the pair comprising a lens 136 and a rim portion 138 extending around the lens 138. The pair of lenses is symmetrical, but in other embodiments is asymmetrical. At least one of the lens 136 comprises polycarbonate, but in other embodiments comprises at least one of plastic, crystal, and glass, or combinations thereof. At least one of the portions 138 comprises polycarbonate, but in other embodiments comprises at least one of metal, plastic, a natural material, and glass, or combinations thereof. At least one of the members of the pair of lenses is unitary, but in other embodiments is an assembly, such as via fastening, mating, interlocking, adhering, magnetizing, or other assembly manners. The lens retaining portion 104 retain the pair of lenses therein through the rim portions 138, such as via adhering, fastening, interlocking, mating, magnetizing, or other suitable methodologies. Such type of retaining can be selectively removable or permanent. Also, note that the lenses 138 can be of identical or different optical characteristics, such as transparency, translucency, opaqueness, focus, color, shape, size, thickness, weight, volume, mass, or other relevant characteristics.

In one mode of operation, the pivoting of the link 118 with respect to the frame 102 and the pivoting of the arm 126 with respect to the link 118 enables the arm 126 to rotate selectively for using both faces of the frame 102 and for folding flat against both faces of the frame 102. Therefore, when a person desires to wear different eyewear frames for different occasions, yet unable to carry more than one eyewear frame at a time, then the person can wear the device 100 such that the frame 102 is used with one of the faces on one occasion and the frame 102 is then reused with the other face on another occasion, as enabled via selective rotating of the arms 126. Note that the lens retaining portions 104 retain the pair of lenses such that the pair of lenses are interchangeable between the lens retaining portions 104 when the pair of lenses is flipped for switching the frame 102 for use between both faces of the frame 102.

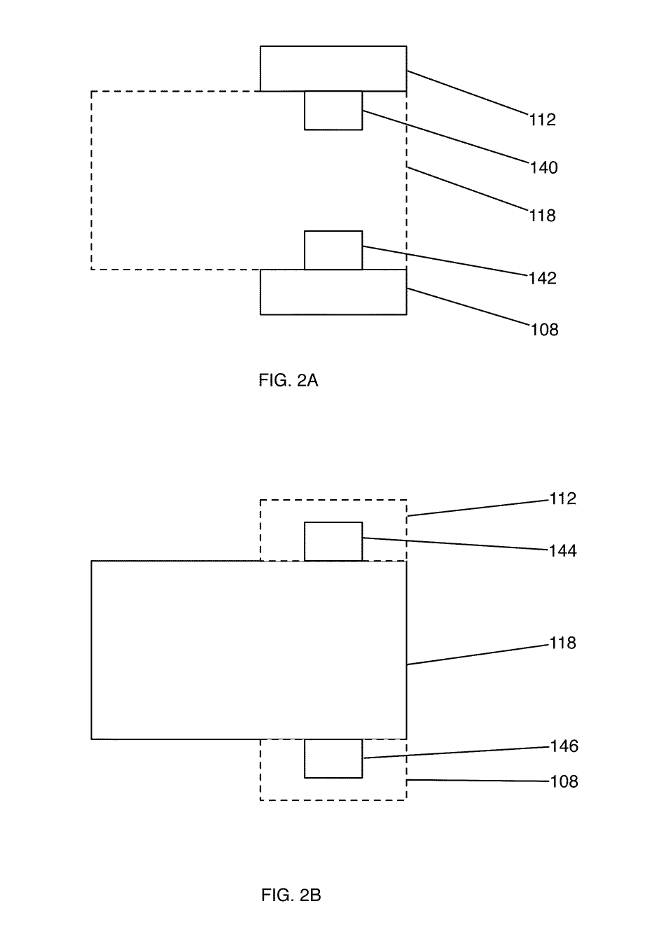

FIG. 2A shows a profile view of an example embodiment of an eyewear frame comprising a pair of protrusions according to the present disclosure.

The portion 112 of the frame 102 comprises a protrusion 140 extending vertically therefrom. The protrusion 140 is unitary with the portion 112, but in other embodiments is an assembly, such as via fastening, mating, interlocking, adhering, magnetizing, or other assembly manners. The protrusion 140 comprises plastic, but in other embodiments comprises at least one of metal, glass, and natural material, or combinations thereof. The protrusion 140 extends into the channel 122 of the link 118. Note that the channel 114 is not needed.

The portion 108 of the frame 102 comprises a protrusion 142 extending vertically therefrom toward the protrusion 140. The protrusion 142 is unitary with the portion 108, but in other embodiments is an assembly, such as via fastening, mating, interlocking, adhering, magnetizing, or other assembly manners. The protrusion 142 comprises plastic, but in other embodiments comprises at least one of metal, glass, and natural material, or combinations thereof. The protrusion 142 extends into the channel 122 of the link 118. Note that the channel 110 is not needed.

The link 118 pivots about the first vertical axis via the protrusion 140 and the protrusion 142 rotating within the channel 122.

In other embodiments, similar configuration is employed via the arm 126 coupling to the link 118 for rotating about the second axis. For example, the protrusion 140 extends vertically from the arm 126 through the link 118 via the channel 120 to facilitate pivoting of the link 118 about the second axis. The protrusion 142 extends vertically from the arm 126 toward said the protrusion 140 through the link 118 via channel 120 to facilitate pivoting of the link 118 about the second axis.

FIG. 2B shows a profile view of an example embodiment of a link comprising a pair of protrusions according to the present disclosure.

The link 118 comprises a protrusion 144 extending vertically therefrom. The protrusion 144 is unitary with the link 118, but in other embodiments is an assembly, such as via fastening, mating, interlocking, adhering, magnetizing, or other assembly manners. The protrusion 144 comprises plastic, but in other embodiments comprises at least one of metal, glass, and natural material, or combinations thereof. The protrusion 144 extends into the channel 114 of the portion 112. Note that the channel 122 is not needed.

The link 118 comprises a protrusion 146 extending vertically therefrom in a direction away from an extension of the protrusion 144. The protrusion 146 is unitary with the link 118, but in other embodiments is an assembly, such as via fastening, mating, interlocking, adhering, magnetizing, or other assembly manners. The protrusion 146 comprises plastic, but in other embodiments comprises at least one of metal, glass, and natural material, or combinations thereof. The protrusion 146 extends into the channel 110 of the portion 108.

The link 118 pivots about the first vertical axis via the protrusion 144 and the protrusion 146 rotating within the channel 114 and the channel 110.

In other embodiments, similar configuration is employed via the arm 126 coupling to the link 118 for rotating about the second axis. For example, the protrusion 144 extends vertically from the link 118 through the arm 126 to facilitate pivoting of the link 118 about the second axis. The protrusion 146 extends vertically from the link 118, away from the protrusion 144, through the arm 126 to facilitate pivoting of the link 118 about the second axis.

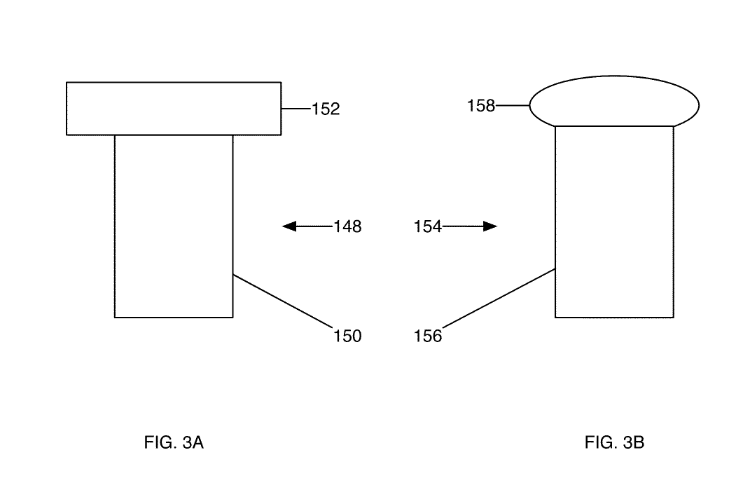

FIG. 3A shows a profile view of an example embodiment of a rotation member according to the present disclosure.

A rotating member 148 is T-shaped, as defined via a leg 150 and a platform 152. The rotating member 148 enables the link 118 to rotate about the leg 150 via the leg 150 extending through the channel 122 or the channel 120, with the platform 152 effectively preventing the link 118 from coming off the leg 150. The rotating member 148 is unitary, but in other embodiment is an assembly, such as via fastening, mating, interlocking, adhering, magnetizing, or other assembly manners. The rotating member 148 comprises plastic, but in other embodiments comprises at least one of metal, glass, and natural material, or combinations thereof.

In some embodiments, the leg 150 extends downwardly from the portion 112 such that the leg 150 extends through the channel 122 of the link 118. The platform 152 limits downward movement of the link 118 during rotation. Note that the channel 114 and the portion 108 are not needed.

In other embodiments, the leg 150 extends upwardly from the portion 108 such that the leg 150 extends through the channel 122 of the link 118. The platform 152 limits upward movement of the link 118 during rotation. Note that the channel 110 and the portion 112 are lacking.

In yet other embodiments, the leg 150 extends downwardly from the portion 128 such that the leg 150 extends through the channel 120 of the link 118. The platform 152 limits downward movement of the link 118 during rotation. Note that the channel 129 and the portion 130 are lacking.

In still other embodiments, the leg 150 extends upwardly from the portion 130 such that the leg 150 extends through the channel 120 of the link 118. The platform 152 limits upward movement of the link 118 during rotation. Note that the channel 131 and the portion 128 are lacking.

FIG. 3B shows a profile view of another example embodiment of a rotation member according to the present disclosure.

A rotating member 154 is defined via a leg 156 and a spheroidal portion 158. The rotating member 148 enables the link 118 to rotate about the leg 156 via the leg 156 extending through the channel 122 or the channel 120, with the portion 158 effectively preventing the link 118 from coming off the leg 156. The rotating member 154 is unitary, but in other embodiment is an assembly, such as via fastening, mating, interlocking, adhering, magnetizing, or other assembly manners. The rotating member 154 comprises plastic, but in other embodiments comprises at least one of metal, glass, and natural material, or combinations thereof.

In some embodiments, the leg 156 extends downwardly from the portion 112 such that the leg 156 extends through the channel 122 of the link 118. The portion 158 limits downward movement of the link 118 during rotation. Note that the channel 114 and the portion 108 are not needed.

In other embodiments, the leg 156 extends upwardly from the portion 108 such that the leg 156 extends through the channel 122 of the link 118. The portion 158 limits upward movement of the link 118 during rotation. Note that the channel 110 and the portion 112 are not needed.

In yet other embodiments, the leg 156 extends downwardly from the portion 128 such that the leg 156 extends through the channel 120 of the link 118. The portion 158 limits downward movement of the link 118 during rotation. Note that the channel 129 and the portion 130 are not needed.

In still other embodiments, the leg 156 extends upwardly from the portion 130 such that the leg 156 extends through the channel 120 of the link 118. The portion 158 limits upward movement of the link 118 during rotation. Note that the channel 131 and the portion 128 are not needed.

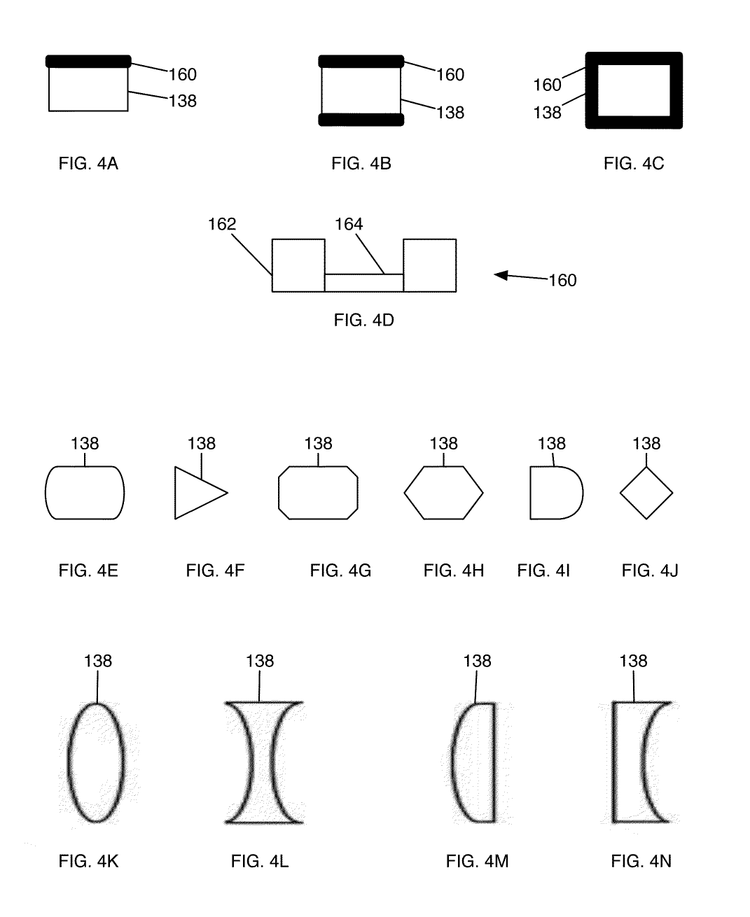

FIG. 4A shows a front view of an example embodiment of a lens receiver in receipt of a lens according to the present disclosure.

A lens receiver 160 is in receipt of the lens 138 and enables lens handling without touching the lens 138, which can affect visibility through the lens 138, such as through fingerprints. Such receipt can be via coupling to the lens 138, such as via fastening, mating, interlocking, adhering, magnetizing, clamping, or other assembly manners. The receiver 160 comprises plastic, but in other embodiments comprises at least one of metal, glass, and natural material, or combinations thereof. The receiver 160 is configured for coupling to the frame 102 such that the lens 138 is removably positioned within one of the lens retaining portions 104, such as via fastening, mating, interlocking, adhering, magnetizing, or other assembly manners, even when the lens 138 is interchanged into another lens retaining portion 104 or flipped for proper optical focus. For example, the receiver 160 in receipt of the lens 138 can be removably inserted into the frame 102 like an image slide is inserted into a slide holder tray of a slide projector.

FIG. 4B shows a front view of an example embodiment of a pair of lens receivers in receipt of a lens according to the present disclosure. A pair of lens receivers 160 is in receipt of the lens 138, which enables lens handling without touching the lens 138, which can affect visibility through the lens 138, such as through fingerprints. Both members of the pair couple to the lens 138 in an identical manner, but in other embodiments, both members of the pair couple to the lens 138 in a manner different from each other. Also, both members of the pair couple to the frame 102 in an identical manner, but in other embodiments, both members of the pair couple to the frame 102 in a manner different from each other.

FIG. 4C shows a front view of an example embodiment of a frame containing a lens according to the present disclosure. A single receiver 160 forms a frame around the lens 138. In other embodiments, a plurality of lens receivers 160 form such frame around the lens 138. The receivers 160 are coupled independently of each other and not secured to each other. However, in other embodiments, at least two of the receivers 160 are coupled dependently on each other or secured to each other. At least one of the receivers 160 is configured for coupling to the frame 102, as described herein. Alternatively, all of the receivers are configured for coupling to the frame 102, as described herein.

FIG. 4D shows a profile view of an example embodiment of a lens receiver according to the present disclosure. The lens receiver 160 is U-shaped, as defined via a pair of walls 162 and a base 164 spanning therebetween. The lens 138 is placed onto the base 164 between the walls 162, with the walls 162 exerting inward force onto the lens 138 to hold the lens 138 is place.

FIG. 4E shows a front view of an example embodiment of a lens in a squashed rectangle shape according to the present disclosure. The lens 138 has a squashed rectangle shape.

FIG. 4F shows a front view of an example embodiment of a lens in a triangular shape according to the present disclosure. The lens 138 has a triangular shape.

FIG. 4G shows a front view of an example embodiment of a lens in a beveled rectangle shape according to the present disclosure. The lens 138 has a beveled rectangle shape.

FIG. 4H shows a front view of an example embodiment of a lens in a hexagon shape according to the present disclosure. The lens 138 has a hexagon shape.

FIG. 4I shows a front view of an example embodiment of a lens in a D-shape according to the present disclosure. The lens 138 has a D-shape.

FIG. 4J shows a front view of an example embodiment of a lens in a rhombus shape according to the present disclosure. The lens 138 has a rhombus shape.

FIG. 4K shows a profile view of an example embodiment of a biconvex lens according to the present disclosure. The lens 138 is biconvex.

FIG. 4L shows a profile view of an example embodiment of a biconcave lens according to the present disclosure. The lens 138 is biconcave.

FIG. 4M shows a profile view of an example embodiment of a plano-convex lens according to the present disclosure. The lens 138 is plano-convex.

FIG. 4N shows a profile view of an example embodiment of a plano-concave lens according to the present disclosure. The lens 138 is plano-concave.

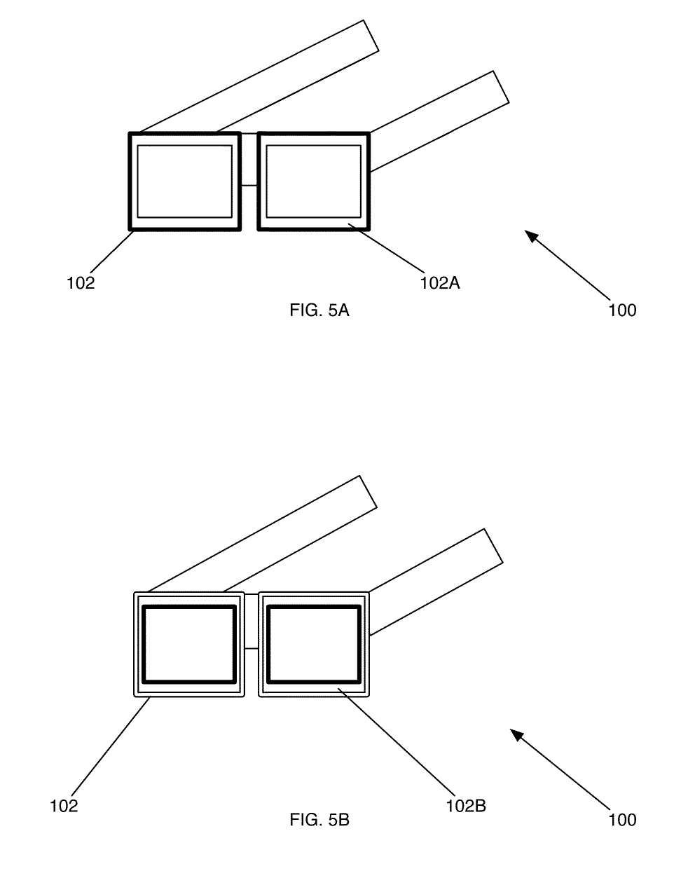

FIG. 5A shows a perspective view of an example embodiment of an eyewear device comprising a first face according to the present disclosure. The frame 102 has a first face 102A.

FIG. 5B shows a perspective view of an example embodiment of an eyewear device comprising a second face according to the present disclosure. The frame 102 has a second face 102B different from the face 102A.

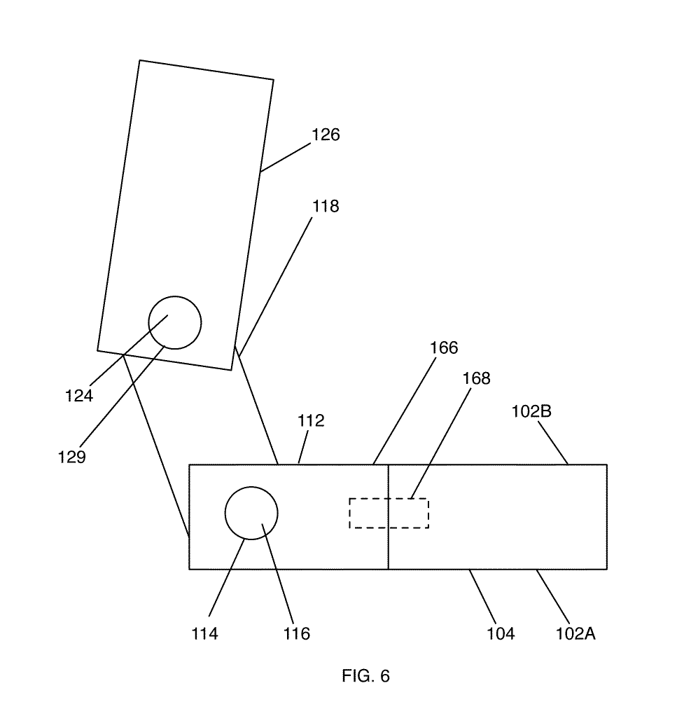

FIG. 6 shows a top view of an example embodiment of an eyewear device comprising a horizontal axis pivoting member according to the present disclosure. A horizontal pivoting member 166 comprises at least one of the portion 112 and the portion 108, whether in a unitary manner or an assembly manner. The pivoting member 166 comprises plastic, but in other embodiments comprises at least one of metal, glass, and natural material, or combinations thereof. The pivoting member 166 is coupled to the frame 102 via a shaft 168, between the first face 102A and the second face 102B. The shaft 168 comprises plastic, but in other embodiments comprises at least one of metal, glass, and natural material, or combinations thereof. The shaft 168 can be smooth, threaded, fluted, spiked, rugged, or slotted. The shaft 168 is secured to one of the pivoting member 166 and the frame 102, whether in a unitary manner or an assembly manner, such as via adhesion, magnetism, fastening, clamping, mating, interlocking, or other methods of assembly. Alternatively, the shaft 168 is unsecured to the pivoting member 166 and the frame 102. The shaft 168 can be coupled to an elastic member or a biasing member to limit free rotation. Alternatively, at least one of the pivoting member 166 and the frame 102 comprises a rotation limiter, such as a protrusion, a wall, a bump, or other suitable methodologies. Resultantly, the pivoting member 166 pivots about a horizontal axis, such as via the shaft 168, with respect to the frame 102. Note that the pivoting member 166 can pivot over, such as in an inverted U-shaped trajectory, or under, such as in a U-shaped trajectory.

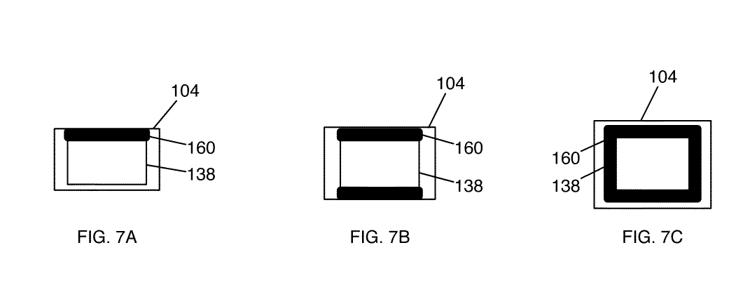

FIG. 7A shows a front view of an example embodiment of an eyewear frame hosting a lens receiver in receipt of a lens according to the present disclosure.

The lens retaining portion 104 removably hosts the lens 138, as placed via the receiver 160. For example, the lens 138, as held via the receiver 160, can be removably inserted, such as via gravitational dropping, into the lens retaining portion 104, like an image slide is inserted into a slide holder tray of a slide projector. Upon insertion, the lens retaining portion 104 secures at least one of the receiver 160 and the lens 138 in place, such as via mating, interlocking, magnetizing, or other removably inserting methods. In order to remove, a user pulls the lens 138 out from the lens retaining portion 104 via the receiver 160, without leaving fingerprints on the lens 138.

FIG. 7B shows a front view of an example embodiment of an eyewear frame hosting a pair of lens receivers in receipt of a lens according to the present disclosure. The lens retaining portion 104 removably hosts the lens 138, as placed via the receivers 160. For example, the lens 138, as held via the receivers 160, can be removably inserted, such as via lateral sliding, into the lens retaining portion 104, like an image slide is inserted into a slide holder tray of a slide projector. Upon insertion, the lens retaining portion 104 secures at least one of the lens 138 and at least one of the receivers 160 in place, such as via mating, interlocking, magnetizing, or other removably inserting methods. In order to remove, a user pulls the lens 138 out from the lens retaining portion 104 via the receivers 160, without leaving fingerprints on the lens 138.

FIG. 7C shows a front view of an example embodiment of an eyewear frame hosting a frame containing a lens according to the present disclosure. The lens retaining portion 104 removably hosts the lens 138, as placed via the receivers 160. For example, the lens 138, as held via the receivers 160, can be removably inserted, such as via lateral sliding, into the lens retaining portion 104, like an image slide is inserted into a slide holder tray of a slide projector. Upon insertion, the lens retaining portion 104 secures at least one of the lens 138 and at least one of the receivers 160 in place, such as via mating, interlocking, magnetizing, or other removably inserting methods. In order to remove, a user pulls the lens 138 out from the lens retaining portion 104 via the receivers 160, without leaving fingerprints on the lens 138.

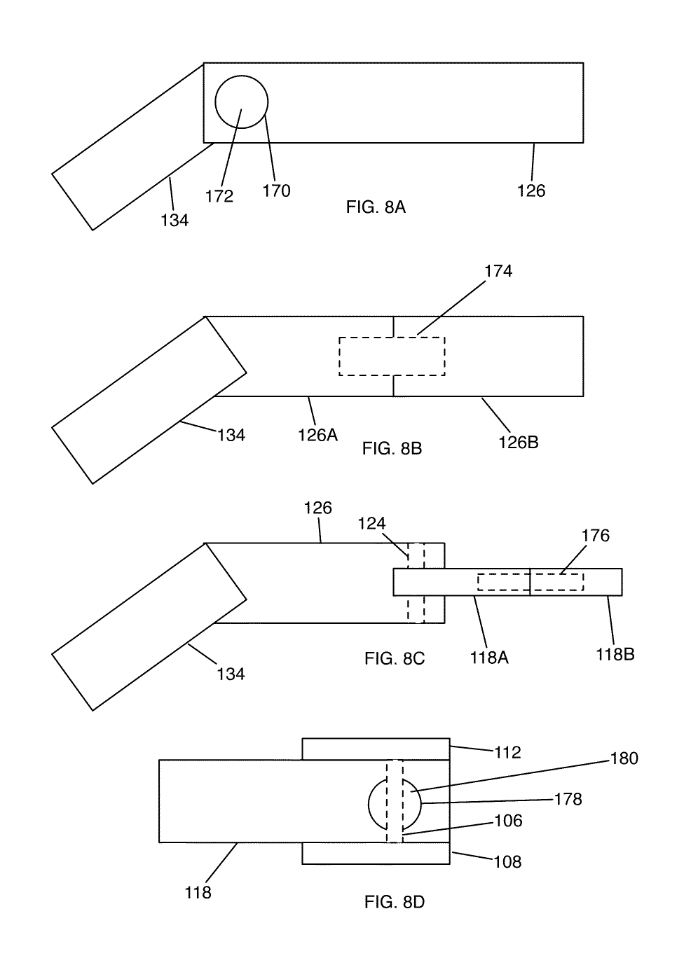

FIG. 8A shows a side view of an example embodiment of an arm comprising a pivoting bend portion according to the present disclosure. The arm 126 defines a channel 170 therethrough. The channel 170 has a circular cross-section, but in other embodiments has a differently shaped cross-section, such as a hexagon.

The channel 170 hosts a pin 172, which is or a part of a dowel, a screw, a rod, a bolt, a shaft, a hinge, or a needle. The pin 172 has a circular cross-section, but in other embodiments, the pin 172 has a cross-section of a different shape, such as a hexagon. The pin 172 comprises metal, but in other embodiments comprises at least one of a stone, and a natural material, or combinations thereof. The pin 172 can be threaded, fluted, or slotted. The pin 172 can comprise a head slotted for fastening with a screwdriver.

The bend portion 134 is coupled to the arm 126 pivotally via the pin 172. Resultantly, the bend portion 134 can rotate selectively about a horizontal axis of rotation, such as when the arm 126 is flipped for use from the first face 102A to use with the second face 102B. Note that such pivoting can be limited, such via coupling to an elastic member or a biasing member to limit free rotation, as housed within at least one of the bend portion 134 and the arm 126. Alternatively, at least one of the bend portion 134 and the arm 126 comprises a rotation limiter, such as a protrusion, a wall, a bump, or other suitable methodologies.

FIG. 8B shows a side view of an example embodiment of an arm comprising a link potion and a bend portion rotating with respect to the link portion according to the present disclosure. The arm 126 comprises a distal portion 126A and a proximal portion 126B. The distal portion 126 is coupled to the bend portion 134, whether in a unitary or an assembly manner, as described herein. The proximal portion 126 is coupled to the link 118.

The arm 126 houses a shaft 174. The shaft 174 comprises plastic, but in other embodiments comprises at least one of metal, glass, and natural material, or combinations thereof. The shaft 174 can be smooth, threaded, fluted, spiked, rugged, or slotted. The shaft 174 is secured to one of the distal portion 126A and the proximal portion 126B, whether in a unitary manner or an assembly manner, such as via adhesion, magnetism, fastening, clamping, mating, interlocking, or other methods of assembly. Alternatively, the shaft 174 is unsecured to the distal portion 126A and the proximal portion 126B. The shaft 174 can be coupled to an elastic member or a biasing member to limit free rotation, as housed within the arm 126. Alternatively, the arm 126 comprises a rotation limiter, such as a protrusion, a wall, a bump, or other suitable methodologies. Resultantly, the distal portion 126A selectively rotates about a horizontal axis, such as via the shaft 174, with respect to the proximal portion 126B, which enables the bend portion 134 to rotate, such as when the arm 126 is flipped for use from the first face 102A to use with the second face 102B. Note that the distal portion 126A can pivot over in any direction.

FIG. 8C shows a side view of an example embodiment of an arm rotating horizontally with respect to a link according to the present disclosure. The link 118 comprises a distal portion 118A and a proximal portion 118B. The distal portion 118A is coupled to the arm 126 pivotally via the pin 124. The proximal portion 118B is coupled to the frame via the pin 116.

The link 118 houses a shaft 176. The shaft 176 comprises plastic, but in other embodiments comprises at least one of metal, glass, and natural material, or combinations thereof. The shaft 176 can be smooth, threaded, fluted, spiked, rugged, or slotted. The shaft 176 is secured to one of the distal portion 118A and the proximal portion 118B, whether in a unitary manner or an assembly manner, such as via adhesion, magnetism, fastening, clamping, mating, interlocking, or other methods of assembly. Alternatively, the shaft 176 is unsecured to the distal portion 118A and the proximal portion 118B. The shaft 176 can be coupled to an elastic member or a biasing member to limit free rotation, as housed within the link 118. Alternatively, the link 118 comprises a rotation limiter, such as a protrusion, a wall, a bump, or other suitable methodologies. Resultantly, the distal portion 118A selectively rotates about a horizontal axis, such as via the shaft 176, with respect to the proximal portion 118B, which enables the bend portion 134 to rotate, such as when the arm 126 is flipped for use from the first face 102A to use with the second face 102B. Note that the distal portion 118A can pivot over in any direction.

FIG. 8D shows a side view of an example embodiment of a link rotating horizontally with respect to an eyewear frame according to the present disclosure. Similar to FIG. 6, the shaft 168 corresponds to a shaft 180 housed within a channel 178 of the pivoting member 166. Resultantly, the pivoting member 166 selectively rotates about a horizontal axis, such as via the shaft 180, with respect to the frame 102, which enables the bend portion 134 to rotate, such as when the arm 126 is flipped for use from the first face 102A to use with the second face 102B. Note that the pivoting member 166 can pivot over, such as in an inverted U-shaped trajectory, or under, such as in a U-shaped trajectory.

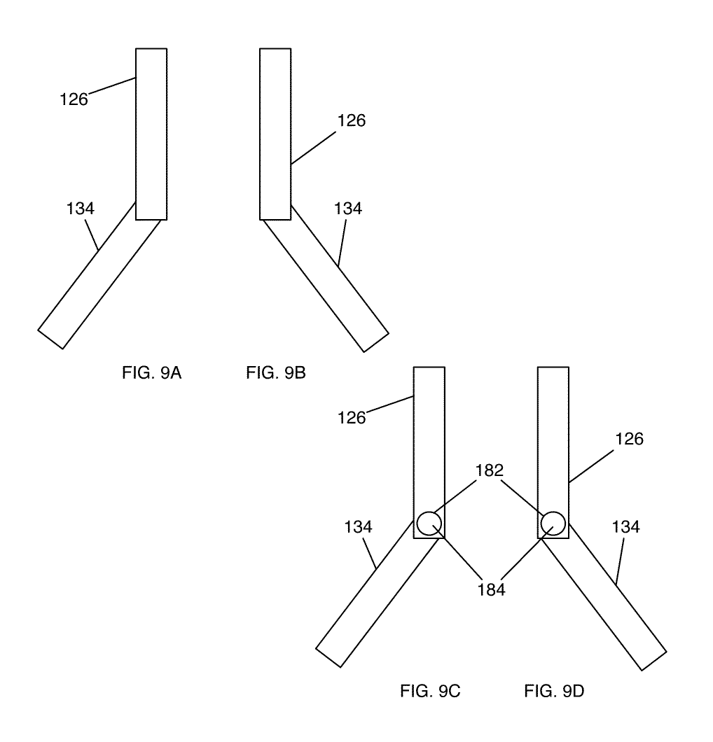

FIG. 9A shows a top view of an example embodiment of a bend portion in a first position according to the present disclosure. The bend portion 134 is in a first position with respect to the arm 126. The first position corresponds to using the bend portion 134 for wearing the frame 102 in accordance with the first face 102A.

FIG. 9B shows a top view of an example embodiment of a bend portion in flipped sideways to a second position according to the present disclosure. The bend portion 134 is in a second position with respect to the arm 126 via selectively flipping laterally from the first position, which can comprise snapping, interlocking, or mating. Such flipping laterally can also be due to a material used. The second position corresponds to using the bend portion 134 for wearing the frame 102 in accordance with the second face 102B.

FIG. 9C shows a top view of an example embodiment of a bend portion in a first position according to the present disclosure. The arm 126 comprises a channel 182. The channel 182 has a circular cross-section, but in other embodiments has a cross-section of a different shape, such as a hexagon.

The channel 182 hosts a pin 184, which is or a part of a dowel, a screw, a rod, a bolt, a shaft, a hinge, or a needle. The pin 184 has a circular cross-section, but in other embodiments, the pin 184 has a cross-section of a different shape, such as a hexagon. The pin 184 comprises metal, but in other embodiments comprises at least one of a stone, and a natural material, or combinations thereof. The pin 184 can be sscrewdriver.

The bend portion 134 is coupled to the arm 126 via the pin 184. Resultantly, the bend portion 134 can rotate selectively about a horizontal axis of rotation, such as when the arm 126 is flipped for use from the first face 102A to use with the second face 102B. Note that such pivoting can be limited, such via coupling to an elastic member or a biasing member to limit free rotation, as housed within at least one of the bend portion 134 and the arm 126. Alternatively, at least one of the bend portion 134 and the arm 126 comprises a rotation limiter, such as a protrusion, a wall, a bump, or other suitable methodologies.

The bend portion 134 is in a first position with respect to the arm 126. The first position corresponds to using the bend portion 134 for wearing the frame 102 in accordance with the first face 102A.

FIG. 9D shows a top view of an example embodiment of a bend portion in pivoted sideways to a second position according to the present disclosure. The bend portion 134 is in a second position with respect to the arm 126 via selectively rotating laterally from the first position. The second position corresponds to using the bend portion 134 for wearing the frame 102 in accordance with the second face 102B.

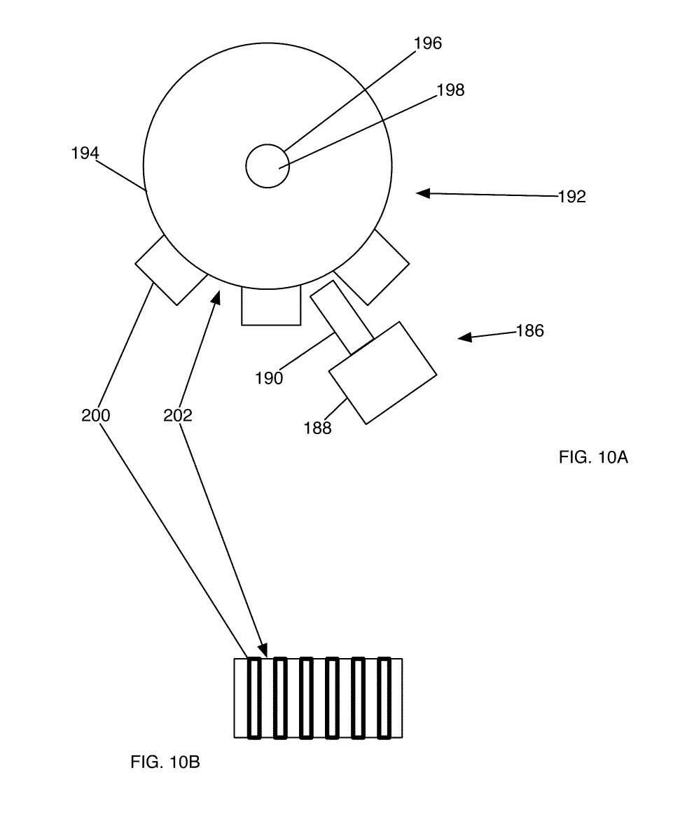

FIG. 10A shows a top view of an example embodiment of a protrusion-depression mechanism according to the present disclosure. FIG. 10B shows a front view of an example embodiment of a depression surface according to the present disclosure. A protrusion-depression mechanism comprises a protrusion portion 186 and a depression portion 192.

The protrusion portion 186 comprising a base 188 and an engager 190 extending therefrom. The protrusion portion 186 comprises plastic, but in other embodiments comprises at least one of metal, glass, and natural material, or combinations thereof. The base 188 and the engager 190 are unitary, but in other embodiments are an assembly, such as via fastening, mating, interlocking, magnetizing, adhering, clamping, or other suitable methods of assembly.

The depression portion 192 comprises a base 194 defining a channel 196 therethrough. The channel 196 has a circular cross-section, but in other embodiments has a cross-section shaped differently, such as a hexagon. The channel 196 hosts a shaft 198 about which the base 194 can rotate. The shaft 198 comprises plastic, but in other embodiments comprises at least one of metal, glass, and natural material, or combinations thereof. The shaft 198 can be smooth, threaded, fluted, spiked, rugged, or slotted. The base 194 has a plurality of teeth 200 arranged thereon, whether in a unitary manner or an assembly manner, such as via fastening, mating, interlocking, magnetizing, adhering, clamping, or other suitable methods of assembly. The teeth 200 are spaced apart such that the teeth 200 define a plurality of depressions 202 therebetween.

As the base 194 rotates, the engager 190 engages, such as via meshing, the depressions 202 between the teeth 200. Such engagement allows for controlled movement based on a set of predefined positions corresponding to the depressions 202. In other embodiments, the projection portion 186 rotates with respect to the depression portion 194.

For example, the link 118 comprises the protrusion portion 186 and the arm 126 comprises the depression portion 192 engaging the protrusion portion 186 such that the arm 126 is repositioned thereby, which allows for controlled movement of the arm 126.

For example, the arm 126 comprises the protrusion portion 186 and the link 118 comprises the depression portion 192 engaging the protrusion portion 186 such that the arm 126 is repositioned thereby, which allows for controlled movement of the arm 126.

For example, the link 118 comprises the protrusion portion 186 and the frame 102 comprises the depression portion 192 engaging the protrusion portion 186 such that the link 118 is repositioned thereby, which allows for controlled movement of the link 118.

For example, the frame 102 comprises the protrusion portion 186 and the link 118 comprises the depression portion 192 engaging the protrusion 186 such that the link 118 is repositioned thereby, which allows for controlled movement of the link 118.

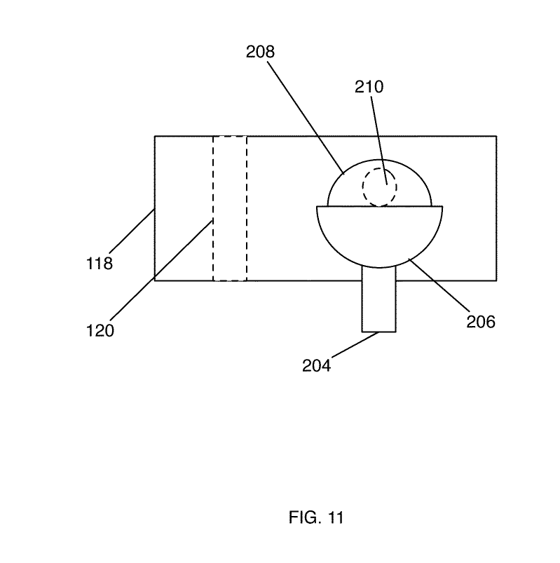

FIG. 11 shows a side view of an example embodiment of a link coupled to an eyewear frame in a ball-and-socket configuration according to the present disclosure. The link 118 is coupled to the frame 102 in a ball-and-socket configuration comprising a stem 210, a ball 208 extending from the stem 210, a stem 204, and a socket 206 coupled to the stem 204. The ball 208 and the stem 210 are unitary, but in other embodiments are an assembly, such as via fastening, mating, interlocking, magnetizing, adhering, clamping, or other suitable methods of assembly. The stem 204 and the socket 206 are unitary, but in other embodiments are an assembly, such as via fastening, mating, interlocking, magnetizing, adhering, clamping, or other suitable methods of assembly. At least one of the ball 208, the stem 210, the stem 204, and the socket 206 comprises plastic, but in other embodiments comprises at least one of metal, glass, and natural material, or combinations thereof. The socket 206 hosts the ball 208. The stem 210 is coupled to the link 118, whether in a unitary manner or an assembly manner, such as via fastening, mating, interlocking, magnetizing, adhering, clamping, or other suitable methods of assembly. The stem 204 is coupled to the frame 102, whether in a unitary manner or an assembly manner, such as via fastening, mating, interlocking, magnetizing, adhering, clamping, or other suitable methods of assembly. Therefore, the ball 208 is associated with the link 118 and the frame 102 is associated with socket 206. However, in other embodiments, the ball 208 is associated with the frame 102 and the link 118 is associated with socket 206. Also, note that such configuration can also be employed between the link 118 and the arm 126 in a similar manner. Resultantly, the link 118 can be rotated selectively based on the ball-and-socket-configuration, which enables the arm 126 to travel accordingly.

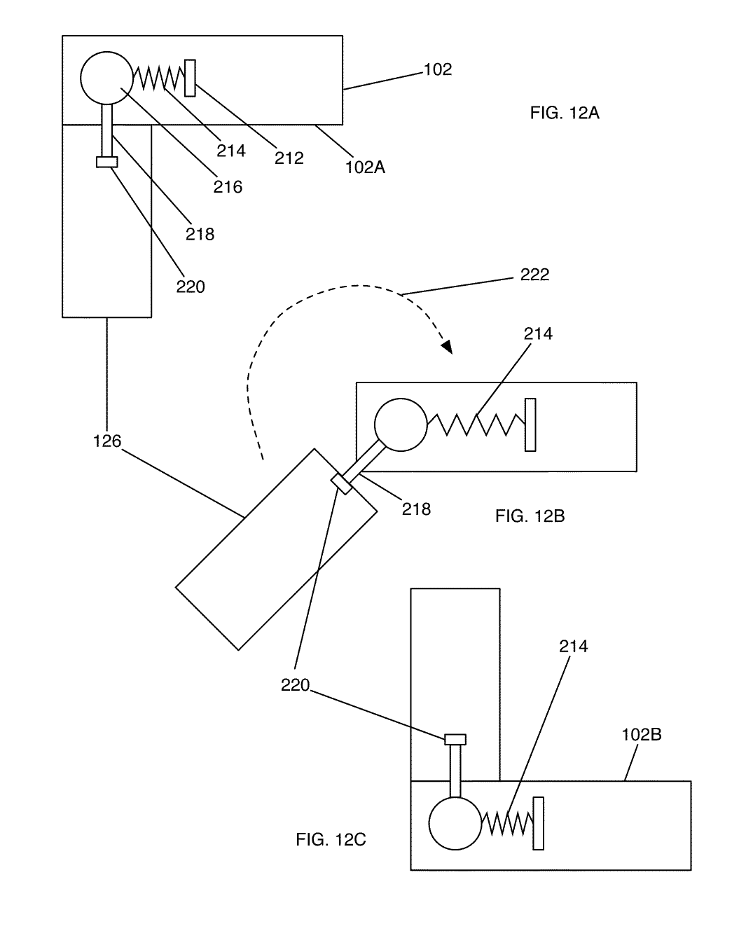

FIG. 12A shows a top view of an example embodiment of an arm coupled to an eyewear frame pivotally for use with a first face according to the present disclosure. The frame 102 hosts an anchor 212, an elastic member 214, and a pin 216.

The anchor 212 is anchored to the frame 102. For example, the anchor 212 is a U-shaped loop secured to the frame 102. The anchor 212 comprises plastic, but in other embodiments comprises at least one of metal, glass, and natural material, or combinations thereof. The anchor 212 is anchored to the frame 102, whether in a unitary manner or an assembly manner, such as via fastening, mating, interlocking, magnetizing, adhering, clamping, or other suitable methods of assembly.

The elastic member 214 is operably coupled to the anchor 212, such as via fastening, mating, interlocking, magnetizing, adhering, clamping, or other suitable methods of assembly. For example, the elastic member 214 is a spring, which can be coiled, or a rubber-based tension member.

The pin 216 extends through the frame 102. The pin 216 is or a part of a dowel, a screw, a rod, a bolt, a shaft, a hinge, or a needle. The 216 has a circular cross-section, but in other embodiments, the 216 has a cross-section of a different shape, such as a hexagon. The 216 comprises metal, but in other embodiments comprises at least one of a stone, and a natural material, or combinations thereof. The 216 can be smooth, threaded, fluted, or slotted. The 216 can comprise a head slotted for fastening with a screwdriver.

A rotation member is T-shaped, as defined via a leg 218 and a platform 220, similarly to FIG. 2A. However, in other embodiments, the rotating member is similar to FIG. 2B. The rotating member is unitary, but in other embodiment is an assembly, such as via fastening, mating, interlocking, adhering, magnetizing, or other assembly manners. The rotating member comprises plastic, but in other embodiments comprises at least one of metal, glass, and natural material, or combinations thereof. The leg 218 extends from the pin 216 into the arm 126. As shown in FIG. 2A, the arm 126 is positioned for use of the frame 102 with the face 102A.

FIG. 12B shows a top view of an example embodiment of an arm pivoting under tension via an elastic member according to the present disclosure. Upon desire to switch the frame 102 from use with the face 102A to use with the face 102B, a user pulls the arm 126 away from the pin 216, which unlocks the arm 126 for vertical rotational movement, such that the platform 220 contacts the arm 126 and thereby limits outward movement of the arm 126. Also, such pulling of the arm 126 tenses the elastic member 214 such that the elastic member 214 pulls the arm 126 inward. The arm 126 is vertically rotated according to an arcuate trajectory 222.

FIG. 12C shows a top view of an example embodiment of an arm coupled to an eyewear frame after pivoting for use with a second face according to the present disclosure.

The arm 126 is vertically rotated for use with the face 102B. Note that when the user bring the arm 126 to such position, the user lets go of the arm 126, which thereby reduces tension of the elastic member 214 and pulls the arm 126 into a position for use with second face 102 and the platform 220 is brought back into its original position.

In other embodiments, the horizontal pivoting member 166 comprises the elastic member 214. In still other embodiments, the arm 126 includes the bend portion 134 and the arm 126 is rotatable with respect to the pivoting member 166 such that the bend portion 134 facilitates switching of the frame 102 for use from the first face 102A to the second face 102B based on the arm 126 horizontally pivoting via the pivoting member 166. In yet other embodiments, the arm 126 pivots about the pin 216 via the projection portion 186 and the depression portion 192, in any combination.

In additional embodiments, the frame 102 and the link 118 are coupled magnetically. In still other embodiments, the link 118 and the arm 126 are coupled magnetically.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. All of these modifications and variations are included in the present disclosure. The scope of the present disclosure is defined by the claims, which includes known equivalents and unforeseeable equivalents at the time of filing of the present disclosure.

What is claimed is:

1. A device comprising:
an eyewear frame;
a link coupled to said eyewear frame for pivoting about a first vertical axis;
an arm coupled to said link for pivoting about a second vertical axis.

2. The device of claim 1, further comprising:
a pin extending through said eyewear frame and said link, wherein said pin facilitating pivoting of said link about said first axis.

3. The device of claim 1, further comprising:
a pin extending through said arm and said link, wherein said pin facilitating pivoting of said arm about said second axis.

4. The device of claim 1, further comprising:
a first protrusion extending vertically from said eyewear frame, wherein said first protrusion extending through said link to facilitate pivoting of said link about the first axis; and
a second protrusion extending vertically from said eyewear frame toward said first protrusion, wherein said second protrusion extending through said link to facilitate pivoting of said link about the first axis.

5. The device of claim 1, further comprising:
a pair of lenses, wherein said eyewear frame comprising a pair of lens retaining portions, a first face, and a second face, wherein said portions retaining said lenses such that said lenses are interchangeable between said portions when flipped for switching said eyewear frame for use from said first face to said second face.

6. The device of claim 5, further comprising:
a lens receiver coupled to one of said lens, wherein said receiver is configured for coupling to said eyewear frame.

7. The device of claim 6, wherein said lens receiver framing said one of said lens.

8. The device of claim 5, further comprising:
a plurality of lens frame members coupled to one of said lens, wherein said lens frame members fully enclosing said one of said lens, wherein at least one of said lens frame members is configured for coupling to said eyewear frame.

9. The device of claim 1, wherein said eyewear frame comprising a pivoting member for horizontal axis pivoting thereabout, wherein said eyewear frame comprising a first face and a second face, wherein said link is coupled to said eyewear frame via said pivoting member such that said arm is horizontally pivoted thereby for switching said eyewear frame for use from said first face to said second face.

10. The device of claim 9, wherein said arm comprising a bend portion rotating about said arm such that said bend portion facilitates switching of said eyewear frame for use from said first face to said second face based on said arm horizontally pivoting via said pivoting member.

11. The device of claim 9, wherein said arm comprising a bend portion, wherein said arm is rotatable with respect to said link such that said bend portion facilitates switching of said eyewear frame for use from said first face to said second face based on said arm horizontally pivoting via said pivoting member.

12. The device of claim 9, wherein said arm comprising a bend portion, wherein said link is rotatable with respect to said frame such that said bend portion facilitates switching of said eyewear frame for use from said first face to said second face based on said arm horizontally pivoting via said pivoting member.

13. The device of claim 1, wherein said eyewear frame comprising a first face and a second face, wherein said arm comprising a bend portion configured for flipping between a first position and a second position, wherein said first position corresponding to use of said eyewear frame based on said first face and said second position corresponding to use of said eyewear frame based on said second face.

14. The device of claim 1, wherein said link comprising a protrusion and said arm comprising a plurality of depressions configured for engaging said protrusion such that said arm is repositioned thereby.

15. The device of claim 1, wherein said arm comprising a protrusion and said link comprising a plurality of depressions configured for engaging said protrusion such that said arm is repositioned thereby.

16. The device of claim 1, wherein said link comprising a protrusion and said eyewear frame comprising a plurality of depressions configured for engaging said protrusion such that said link is repositioned thereby.

17. The device of claim 1, wherein said eyewear frame comprising a protrusion and said link comprising a plurality of depressions configured for engaging said protrusion such that said link is repositioned thereby.

18. The device of claim 1, wherein said link is coupled to said eyewear frame in a ball-and-socket configuration.

19. The device of claim 1, wherein said eyewear frame and said link are coupled magnetically.

20. The device of claim 1, wherein said link and said arm are coupled magnetically.

21. The device of claim 1, further comprising:
a first protrusion extending vertically from said arm, wherein said first protrusion extending through said link to facilitate pivoting of said link about the second axis; and
a second protrusion extending vertically from said arm toward said first protrusion, wherein said second protrusion extending through said link to facilitate pivoting of said link about the second axis.

22. The device of claim 1, further comprising:
a first protrusion extending vertically from said link, wherein said first protrusion extending through said eyewear frame to facilitate pivoting of said link about the first axis; and
a second protrusion extending vertically from said link away from said first protrusion, wherein said second protrusion extending through said eyewear frame to facilitate pivoting of said link about the first axis.

23. The device of claim 1, further comprising:
a first protrusion extending vertically from said link, wherein said first protrusion extending through said arm to facilitate pivoting of said link about the second axis; and
a second protrusion extending vertically from said link away from said first protrusion, wherein said second protrusion extending through said arm to facilitate pivoting of said link about the second axis.

24. A device comprising:
an eyewear lens;
a lens frame fully enclosing said lens, wherein said lens frame is configured for coupling to an eyewear frame removably.

25. A device comprising:
an eyewear frame comprising a first face, a second face, and an elastic member;
an arm coupled to said eyewear frame for vertical axis pivoting thereabout to enable selective use of said eyewear frame based on said first face and said second face, wherein said elastic member is in tension as said arm is vertical axis pivoted between a first position and a second position, wherein said first position corresponding to use of said eyewear frame based on said first face and said second position corresponding to use of said eyewear frame based on said second face.

26. The device of claim 25, further comprising:
a pair of lenses, wherein said eyewear frame comprising a pair of lens retaining portions, wherein said portions retaining said lenses such that said lenses are interchangeable between said portions when flipped for switching said eyewear frame for use from said first face to said second face.

27. The device of claim 26, further comprising:
a lens receiver coupled to one of said lens, wherein said receiver is configured for coupling to said eyewear frame.

28. The device of claim 27, wherein said lens receiver framing said one of said lens.

29. The device of claim 26, further comprising:
a plurality of lens frame members coupled to one of said lens, wherein said lens frame members fully enclosing said one of said lens, wherein at least one of said lens frame members is configured for coupling to said eyewear frame.

30. The device of claim 25, wherein said eyewear frame comprising a pivoting member for horizontal axis pivoting thereabout, wherein said pivoting member comprising said elastic member, wherein said pivoting member pivoting said arm horizontally for switching said eyewear frame for use from said first face to said second face.

31. The device of claim 30, wherein said arm comprising a bend portion rotating about said arm such that said bend portion facilitates switching of said eyewear frame for use from said first face to said second face based on said arm horizontally pivoting via said pivoting member.

32. The device of claim 30, wherein said arm comprising a bend portion, wherein said arm is rotatable with respect to said pivoting member such that said bend portion facilitates switching of said eyewear frame for use from said first face to said second face based on said arm horizontally pivoting via said pivoting member.

33. The device of claim 25, wherein said arm comprising a bend portion configured for flipping between a first posture and a second posture, wherein said first posture corresponding to use of said eyewear frame based on said first face and said second posture corresponding to use of said eyewear frame based on said second face.

34. The device of claim 25, wherein said eyewear frame comprising a protrusion and said arm comprising a plurality of depressions configured for engaging said protrusion such that said arm is repositioned thereby.

35. The device of claim 25, wherein said arm comprising a protrusion and said eyewear frame comprising a plurality of depressions configured for engaging said protrusion such that said arm is repositioned thereby.

36. The device of claim 25, wherein said eyewear frame and said arm are coupled magnetically.
